(19) United States
(12) Patent Application Publication
(10) Pub. No.: US 2011/0181728 A1
(43) Pub. Date: Jul. 28, 2011

(54) ELECTRONIC SIDE VIEW DISPLAY SYSTEM

(75) Inventors: Craig A. Tieman, Westfield, IN (US); Michael E. Miller, Rossville, IN (US); Frank Bruce Wiloch, Almont, MI (US)

(73) Assignee: DELPHI TECHNOLOGIES, INC., TROY, MI (US)

(21) Appl. No.: 13/122,013

(22) PCT Filed: Dec. 18, 2009
(86) PCT No.: PCT/US09/68717

§ 371 Date: Mar. 31, 2011

Related U.S. Application Data
(60) Provisional application No. 61/203,252, filed on Dec. 19, 2008.

(51) Int. Cl. H04N 7/18

(52) U.S. Cl. 348/148; 348/E07.085

(57) ABSTRACT

An apparatus provides an electronic replacement for driver and passenger side view minor systems. Specifically, a set of unique features provide enhanced fuel economy, safety and convenience. The invention relies upon electronic imaging cameras and electronic active matrix displays (e.g. LCD, OLED, etc.) for reproducing the image, with the addition of reality enhancing features.

### TECHNICAL FIELD

The present invention relates to apparatus enhancing a driver's visibility or field of view externally of a ground vehicle, such as an automobile, motorcycle, truck or the like.

### BACKGROUND OF THE INVENTION

It is known to provide side view mirrors on vehicles to assist a driver with viewing an area alongside and behind a vehicle. Minors are useful for assisting the driver in seeing obstacles prior to changing lanes or backing up, where the obstacles might otherwise collide with the vehicle. However, conventional side view mirrors have a limited field of view and do not provide the driver with a comprehensive view of the area, so objects in portions of the area alongside and behind a vehicle may not be seen by the driver. These portions where unseen objects may reside are not seen because the conventional side view mirrors have fixed positions after being adjusted by the driver. For example, if the minor position is adjusted by the driver to be optimum for traveling in a forward direction where the driver is observing an adjacent traffic lane rearward the vehicle, then the minor may not be optimally adjusted for backing up where the driver needs to see the area near the rear wheel and rear bumper.

It has been proposed to provide motorized minor position controls to adjust the position of the mirror in response to the vehicle shifting into reverse. However, this provision has an undesirable time response delay due to the mechanical motion, and adds undesirable cost and complexity to the mirror assembly. It is also proposed to provide cameras with motorized aiming controls and displays to supplement the side view minors. As with side view mirrors, mechanically changing the aimed direction of a camera using a mechanical position control system has the same undesirable cost, complexity, and time response delay problems as the motorized mirrors.

Therefore, what is needed is a side view vision system having a camera capturing an image of the area beside and extending rearward a vehicle and a display for displaying a view of a determined portion of the image, where the portion determined is based upon the transmission selector position and is provided without the cost, complexity, and time response delay associated with mechanical position controls. Such a side view vision system may be advantageous in providing a view during forward driving that is optimum for lane changes and similar maneuvers, and a different view during reverse travel that is optimized for that purpose.

Motor vehicles (e.g. cars, trucks, motorcycles, etc.) all have the need to provide drivers with full visibility in all directions for the safe and convenient operation on and off roadways. In particular, visibility to the side and rear of the vehicle in adjacent lanes is needed to prevent lane-change type accidents and to facilitate low-speed maneuvering either forward or backward. Side and rear visibility has traditionally been supplied via the mounting of exterior and interior-mounted mirrors within the driver's field-of-view and aimed such as to provide a complete view to the rear and adjacent lanes. These minors are also regulated safety equipment and must, therefore meet particular regulatory performance standards. There are, however, certain shortcomings of current mirror-based technology, which include:

Negative impact on vehicle fuel economy (e.g. 0.2%-2.0%) due to the additional aerodynamic drag (e.g. 4%-6% of total drag) caused by mirrors;

Incomplete visibility to each side of the vehicle, causing blind spots which can lead to lane-change-type accidents; and

Susceptibility of damage to the mirrors or to adjacent vehicles due to the protrusion of the minor outside the plane of the vehicle.

Prior art U.S. Pat. No. 6,891,563 B2 to Schofield et al. entitled “Vehicular Vision System” describes a vehicle vision system having first and second spatially separated image capture sensors. The first image capture device has a first field of view having a first view portion at least partially overlapping a field of view portion of a second field of view of the second image capture device. A control receives a first image input from the first image capture sensor and a second image input from the second image capture sensor, and generates a composite image synthesized from the first image input and the second image input. A display system displays the composite image.

The specification and teachings of U.S. Pat. No. 6,891,563 B2 is hereby incorporated herein be reference.

The following U.S. and foreign published applications and issued/granted patents are also of interest: US 2007/0182817 A1, U.S. Pat. No. 7,050,908, U.S. Pat. No. 6,738,088, U.S. Pat. No. 7,423,665, U.S. Pat. No. 7,095,569, US 2003/0214584 A1, US 2003/0103141 A1, WO 03/049446 A1, JP 2005/324693 A, JP 4024132 A and JP 2004/155354, and are thereby incorporated herein by reference.

### SUMMARY OF THE INVENTION

The present invention relates to an electronic replacement for driver and passenger side view mirror systems, and provides a set of unique features which enable new possibilities for improved fuel economy, safety and convenience. The present invention relies upon electronic imaging cameras and electronic active matrix displays (e.g. LCD, OLED, etc.) for reproducing the image. Although camera based viewing systems have been proposed previously, the present invention is embodied in specific, unique features which can be incorporated to enhance the information available to the vehicle driver.

A vehicle side view display system includes one or more cameras which are carried on a surface of an associated vehicle to focus on a fixed field of view. Each camera generates output signals as a function of objects disposed throughout the fixed field of view. The camera output signals are fed to a controller which interconnects the camera(s) to a display device. A video processor in the controller displays an electronically reconfigurable image area on the display device optionally depicting (1.) split display screen for combined images, (2.) object recognition enhancement, (3.) automatic compensation for vehicle tilt, and (4.) touch-screen capable display (enabling driver to control display settings and intuitively, also eliminating separate mechanical controls) features of the present invention.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a perspective view of a passenger vehicle equipped with an electronic side view display system embodying the present invention;

FIG. 2, is a perspective view of the operator cockpit of the passenger vehicle of FIG. 1 in an enlarged view, illustrating positioning of the display portion of the electronic side view display system within the vehicle operator's forward field of vision;

FIG. 3, is a block diagram of the electronic side view display system of FIG. 1, illustrating its various inputs as well as its electronic pan and zoom capability;

FIG. 4, is a driver's perspective view of a displayed image area superimposed within the overall field of view of a fixed camera of the electronic side view display system of FIG. 1, wherein augmented reality (i.e. overlaid information) is employed within the image area;

FIG. 5, is an overhead plan view of a passenger vehicle equipped with an electronic side view display system including passenger and driver side view cameras depicting the respective image area of each camera and a collage combining the two image areas in a single split-screen driver display; and

FIGS. 6A-C, depict an automatic yaw/pitch/roll compensation feature of the electronic side view display system which serves to actively maintain a driver selected image area in response to translation of the host vehicle axes with respect to the nominal local ground plane.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

The invention described herein relates to an electronic replacement for driver and passenger side view mirror systems, specifically, a set of unique features which enable new possibilities for improved fuel economy, safety and convenience. The present invention relies upon electronic imaging cameras and electronic active matrix displays (e.g. LCD, OLED, etc.) for reproducing the image. Although camera based viewing systems have been proposed previously, the present invention is embodied in specific, unique features which can be incorporated to enhance the information available to the vehicle driver.

Through the use of an additional video processing component of the system (e.g. field-programmable gate array, graphic processing unit, or equivalent) to accept the raw camera input and process it before sending to the display element, numerous performance enhancements are possible. Specifically, features such as the following are possible:

Electronically-Adjustable Field-Of-View—A fixed minor system for a given vehicle meets applicable regulatory requirements for either flat (i.e. unit magnification), convex (i.e. wider field-of-view) or combined (i.e. split between flat and aspheric) for the particular country-of-sale. They also include motorized mounts which enable the driver to align the minor for best viewing or for the vehicle to automatically reposition the minor view (e.g. such as when in reverse gear). An electronically-adjustable field-of-view would permit a single and common display system to be programmed for any type of mirror-equivalent performance as indicated above. This can enable common hardware/software to be used in various countries yet provide a country-specific image representation. Electronic controls would permit the driver to aim the viewed image simply by commanding a different grouping of image pixels from the camera. Additionally, in certain vehicle modes, such as low-speed maneuvering or backing, the viewed image could be adjusted to include a wider field-of-view or a more downward viewing angle (i.e. digital pan and zoom). No physically moving parts are required to enable this feature, only a camera with a sufficiently-large field-of-view to cover the total possible viewing area.

Augmented Reality—A fixed minor system provides drivers with information related to the distance to an object or vehicle using depth perception cues. Those cues include stereoscopic vision and relative size in the minor (achieved through extended use and familiarization). A single camera and display eliminates the stereoscopic vision as a form of depth perception, leaving only relative size as a cue. In the event that non-traditional fields-of-view are used, the relative size of objects will no longer match the minor being replaced and drivers would be left without any equivalent depth perception cues. To compensate for this and add additional useful information, displayed images would be augmented with overlaid visual information to aid the driver when judging distances. Examples include: horizontal lines at various distances behind the vehicle (e.g. rear bumper, 20 ft., 40 ft.), angled lines which correspond with outside lane markings, icons which indicate safe or unsafe vehicle separations for lane changes based upon image-based calculation of distance to objects.

Split Screen/Multiple Images—Additional image display modes are possible which would be impossible with traditional minors. For example, a display screen could be divided into two or more “zones”, each containing an image from a different camera. In this way, a driver need only look in a single location to know whether any obstacles are to the sides or rear of the vehicle. This would also provide a fail-safe means to give drivers all useful information in the event of a single display failure if each camera was connected to all display systems.

Object Recognition Enhancement—Through video processing of the image, certain items of interest could be visually-enhanced while background information could be visually-suppressed to enhance driver recognition capability. For example, only visual information related to the adjacent lane and vehicles within could be enhanced or simply shown while background scene information could be “dimmed” or made less visible.

Automatic Compensation For Vehicle Tilt—Through the use of either integral accelerometers/inclinometers or data from exiting vehicle accelerometers/inclinometers, the displayed image could be automatically compensated for vehicle tilt caused by carrying heavy loads or towing heavy trailers to maintain proper displayed images. Furthermore, this feature can be used to mitigate the effects of vehicle “topping” and “bottoming” in undulating road courses.

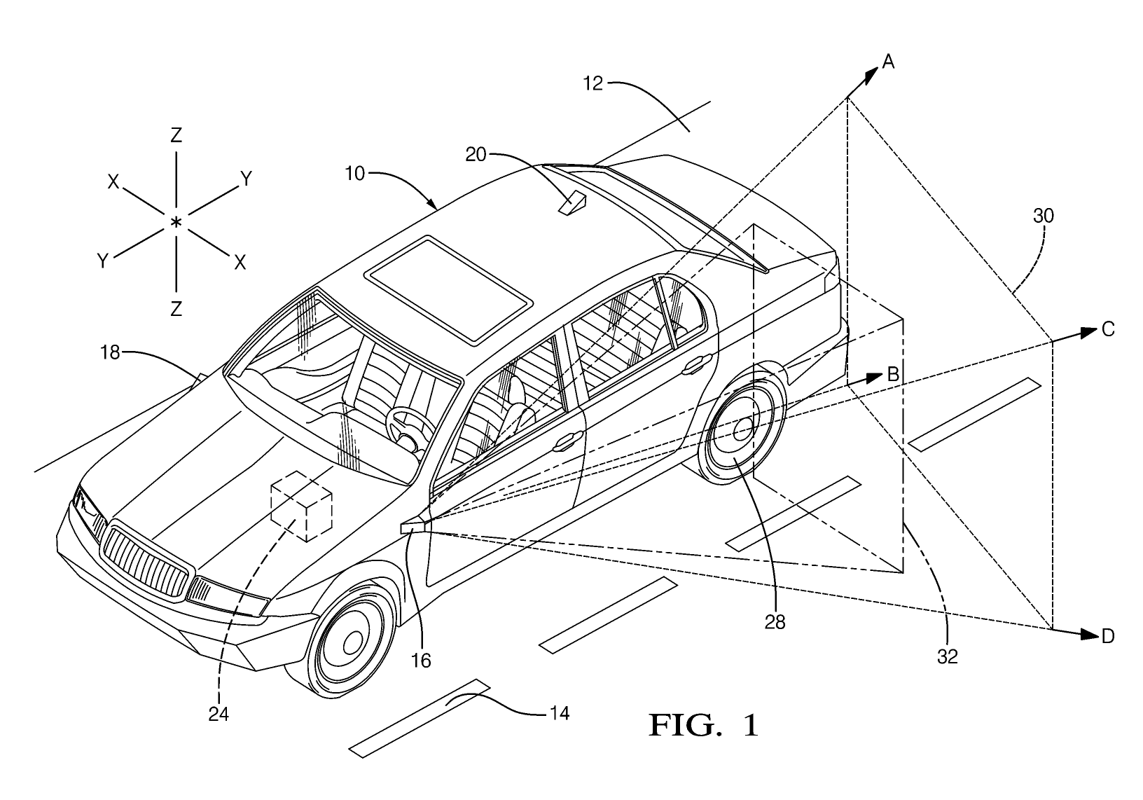

FIG. 1 depicts a vehicle 10 operated by a driver (not illustrated) along a roadway 12 having a region adjacent vehicle 10. Roadway 12 includes lane markers, referred to herein as boundary 14. The roadway 12 could be a multi-lane highway, where the adjacent region is a traffic lane where other vehicles travel in the same direction as vehicle 10, or a two-lane road, where the adjacent region is a traffic lane where other vehicles travel in the opposite direction. Alternatively, the vehicle could be parallel parked on a shoulder of a roadway and the region is a traffic lane, or the vehicle could be in a driveway, where the region is a lawn boarding the driveway. The vehicle 10 lacks a conventional side view external minor. In its place, the vehicle 10 includes fixed, rearwardly directed driver and passenger side view cameras 16 and 18, respectively, and a roof mounted center rear view minor 20, collectively disposed to assist the driver with observing an area alongside and extending rearwardly of the vehicle and identifying objects adjacent to the vehicle.

Referring to FIGS. 1-3, in accordance with this invention, vehicle 10 is also equipped with an electronic side view display system 22 that includes at least one camera 16, a controller 24, and a display 26. The controller 24 receives a raw feed signal from camera 16 corresponding to an image captured by the camera and outputs a view of a portion of the image to display 26, thereby providing the driver with a view of a portion of the image. The controller 24 is preferably positioned in the vehicle 10 so the connections to camera 16 and display 26 are convenient to make.

Camera 26 is fixedly mounted to the vehicle 10 and positioned on the vehicle 10 to capture an image covering the area alongside the vehicle 10, from forward of rear wheel 11 to rearward of rear wheel 28 and extending rearward the vehicle. The camera 16 is aimed and configured so the image includes areas to supplement the driver's forward field of vision and peripheral vision. Camera 16 captures an image of the area indicated by arrows A, B, C, and D, which are defined, for purposes of this application as its “field of vision” 30. Arrows B and D intersect with the surface of the roadway, and arrows A and C point above the horizon surrounding the vehicle. As indicated by arrows A and B, the field of vision in this embodiment includes the side of vehicle 10 and shows a rear wheel 11. Also in this embodiment, arrows C and D are oriented so the image includes the edge of the driver peripheral vision. The camera 16 is preferably of known standard design and is applicable to all configurations of vehicles. The area captured by the camera 16 is adjusted electronically as necessary for different types of vehicles such as trucks and off-road equipment.

Display 26 receives an output from controller 24 for showing a view of a portion of the field of vision 30 to the driver to supplement the driver's unaided (forward and peripheral) field of view. Display 26 is preferably positioned so the driver can observe an image area 32 area showing items adjacent and behind the vehicle 10 without altering his forward field of vision, thereby decreasing driver distraction and improving safety. The display device 26 could be used only by the side view vision system, or could be a general purpose display for conveying other information to the driver such as driving directions or engine operation information.

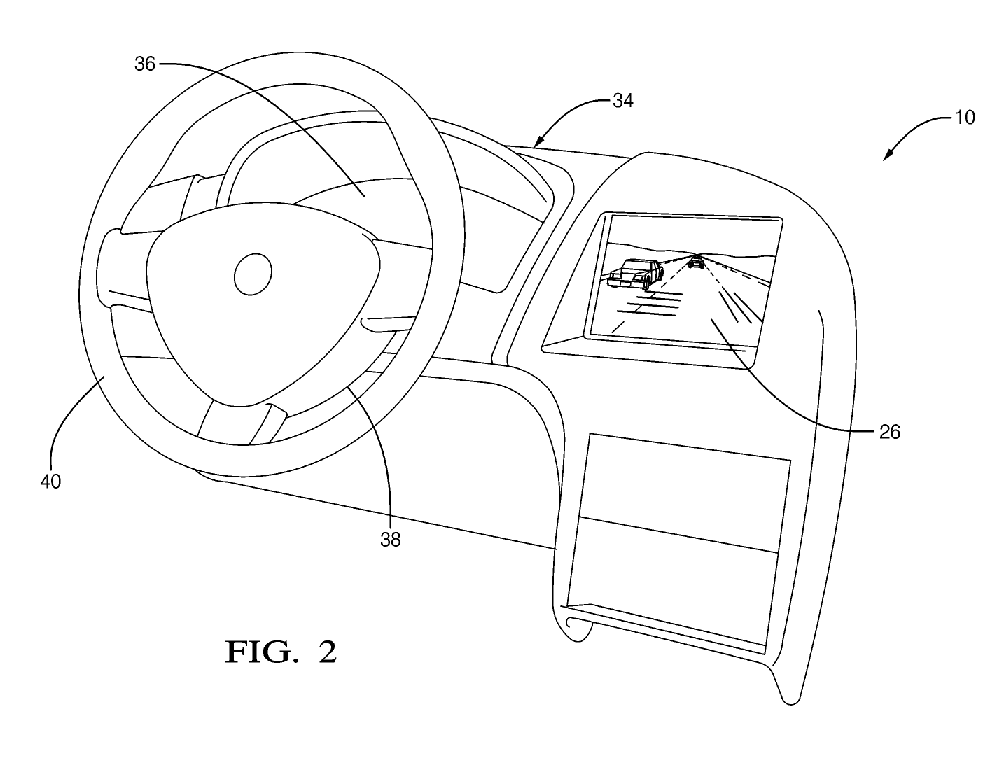

FIG. 2 shows an exemplary interior of vehicle 10 having an instrument panel 34. Instrument panel 34 includes a transmission indicator, a speedometer 36, display 26, and a steering column 38 supporting a turn-signal selector, a steering wheel 40, and a transmission selector. Speedometer 36 indicates the speed of the vehicle. Turn-signal selector is used by the driver to activate lights on the vehicle for indicating the driver's intent to make a turn or lane change. Steering wheel 40 is moved by the driver to establish a condition for straight travel or turning in preparation to moving the vehicle, and steering the vehicle when the vehicle is moving. Transmission selector is moved by the driver to select a transmission gear. In response to moving transmission selector, a transmission indicator changes to indicate the gear selected. If the driver wishes to have the vehicle remain stationary, transmission selector may be moved to a park position, whereupon the display on the instrument panel confirms the P selection, for example by increasing the luminous intensity relative to other gear selector positions. If the driver wishes to travel forward, the transmission selector may be moved to a drive gear, whereupon D indicating drive may be indicated. If the driver wishes to travel backward, transmission selector may be moved to a reverse gear, whereupon R indicating reverse may be indicated. Alternately, the transmission selector could be located on the console between the driver and passenger seats or be coupled to a manual type transmission. Display 26 is shown to the right of steering column 38, but could be located anywhere on instrument panel. For example, locating display 26 between speedometer 36 and the driver's side rear view camera 16 (FIG. 1) may be a benefit to the driver.

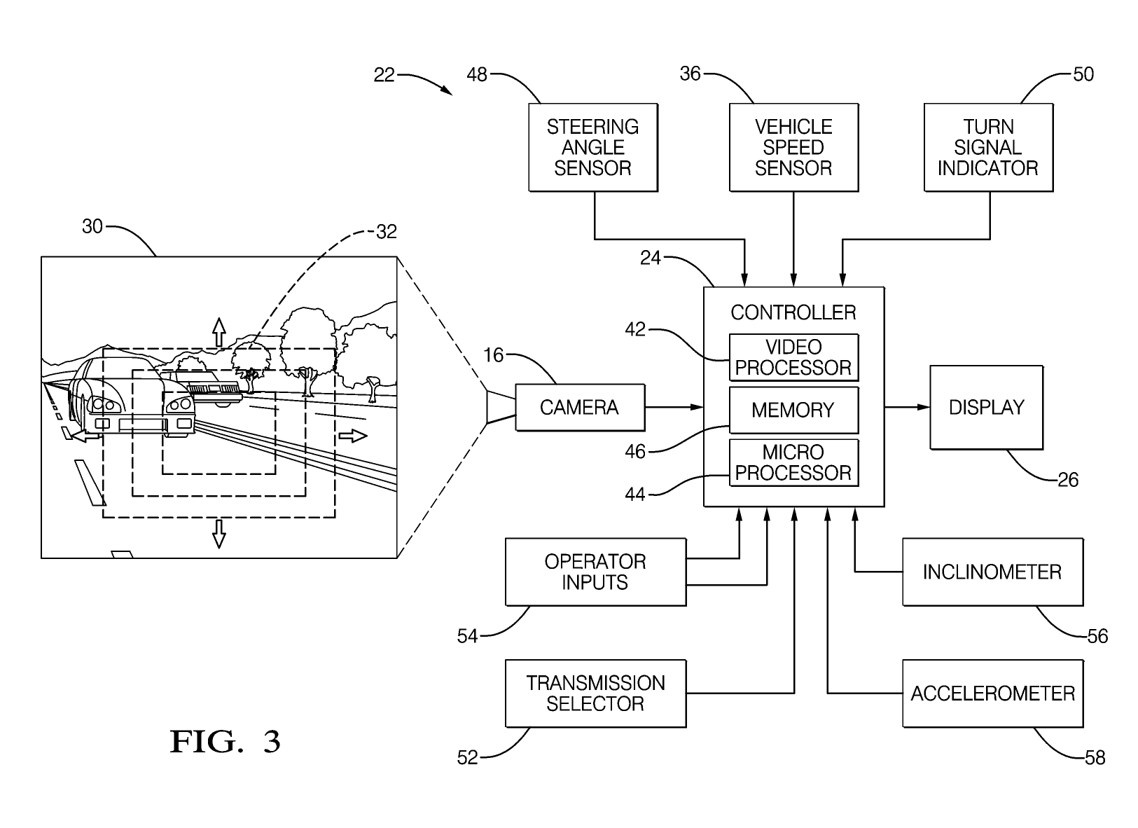

Referring now to FIG. 3, camera 16 captures an image of an area or field of view 30 and outputs a signal to controller 24 corresponding to the image captured. Controller 24 receives the signal from camera 16 and outputs a signal to display 26, where the signal to display 26 is a view of a portion of the image designated for purposes of this application as the “image area” 32. Controller 24 includes a video processor 42, a microprocessor 44 for processing control algorithms and one or more memory devices 46. The video processor 42 and microprocessor 44 can be discrete or integrated within a single device. The controller 24 receives input signals from a steering angle sensor 48, turn signal indicator 50 and a transmission selector 52, as well as vehicle speed sensor 36. Furthermore, the controller 24 receives input signals from various operator inputs 54, a vehicle inclinometer 56 and accelerometer 58.

The controller 24 determines the portion determined for display based on a signal from a transmission selector position 30 indicative of which gear is engaged by the vehicle transmission. Controller 15 can further determine a view for display based on a signal from steering angle sensor 36 that is indicative of the angle of steering wheel 28, a signal from a vehicle speed sensor 32 that corresponds to the vehicle speed indicated on speedometer 26, and a signal from a turn signal indicator 34 that is indicative of the position of turn signal selector 24.

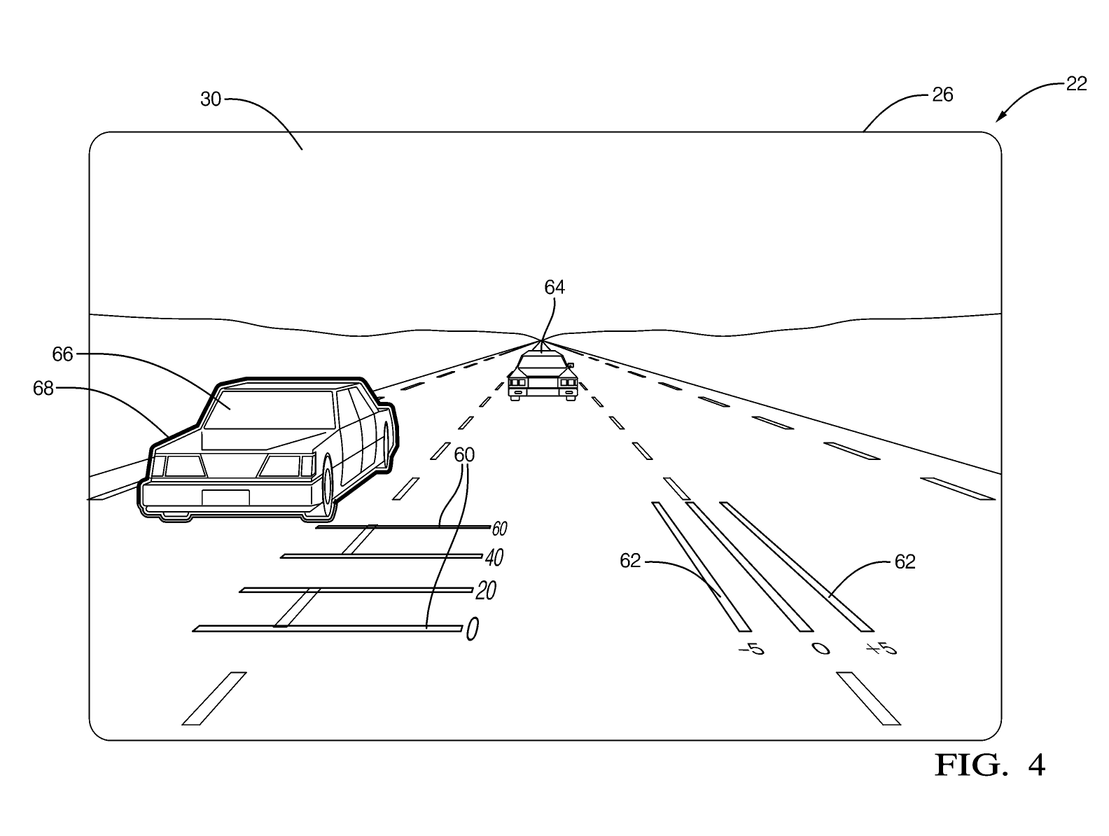

Referring to FIG. 4, a field of vision 30 displayed on a display 26 of an electronic side view display system 22 illustrates augmented reality, wherein naturally occurring depth perception cues of a binocular system are replaced in a monocular system by electronically superimposing grid lines such as lateral, horizontal lines 60 at various distances behind the vehicle (e.g. rear bumper, 20 ft., 40 ft.), and angled lines 62 which correspond with outside lane or boundary markings. In addition, icons which indicate safe or unsafe vehicle separations for lane changes based upon image-based calculation of distance to objects can also be superimposed within the field of vision 30. For example, the image of an object such as a following vehicle 64 or a laterally adjacent vehicle 66 can be highlighted, such as with a boundary box or halo 68 to draw the vehicle operator's attention. Furthermore, the grid lines 60 and 62 can be depicted in fixed relationship to objects in the display or can be adaptively varied as a function of one or more vehicle operating parameters, such as speed, and provide a go-no-go indication for a contemplated lane-change maneuver.

Although the determined portions of the image are portrayed as rectangles, the portions could encompass areas having other shapes and the controller would process the image to provide an image having varying degrees of magnification across the image. In addition, the controller could also place indicia within the portion being displayed to indicate distances from the vehicle, where the direction of the distances not limited to the rearward direction. A user interface to the controller (not shown) would allow the driver to customize the portion displayed for various combinations of transmission gear, turn signal activation, steering angle, and vehicle speed, thereby providing the driver with a view optimized for a particular driver.

FIG. 1 shows camera 16 on the driver side of the vehicle 10. A similar camera 18 could be provided on the passenger side of the vehicle 10 for capturing a similar image of the area along side and extending rearward the passenger side of the vehicle. The portion of the image determined for viewing could be shown on a separate display, or combined with the determined portion of the driver side on a single display. The center and magnification could similarly be determined and adjusted based on various signals indicating vehicle operation.

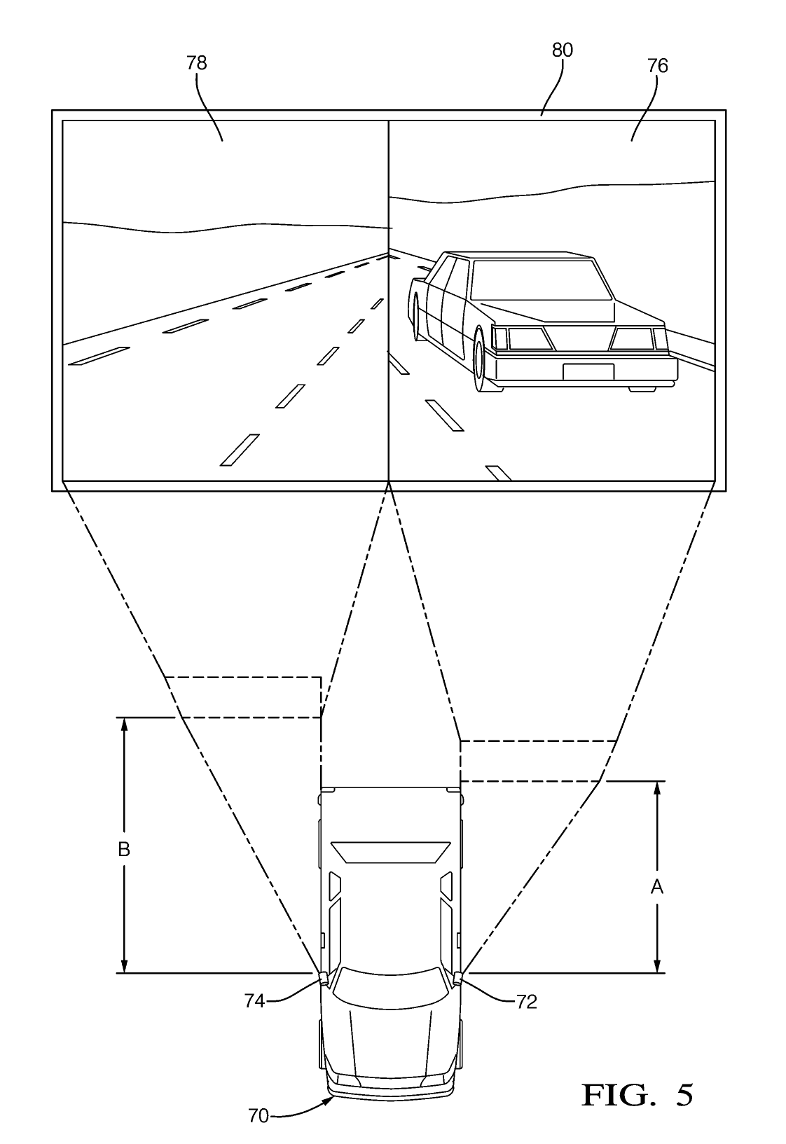

Referring to FIG. 5, a vehicle 70 with an electronic side view display system includes a driver side camera 72 and a passenger side camera 74. Each camera feeds a video processor controller and produces a separate field of vision 76 and 78, respectively, which can be manipulated into a split-screen presentation on a vehicle operator display 80. The cameras 72 and 74 can include image areas which are effectively focused at different distances “A” and “B” at the driver's option. The illustrated 50/50 image split can also be varied (e.g. 60/40, 70/30, or the like).

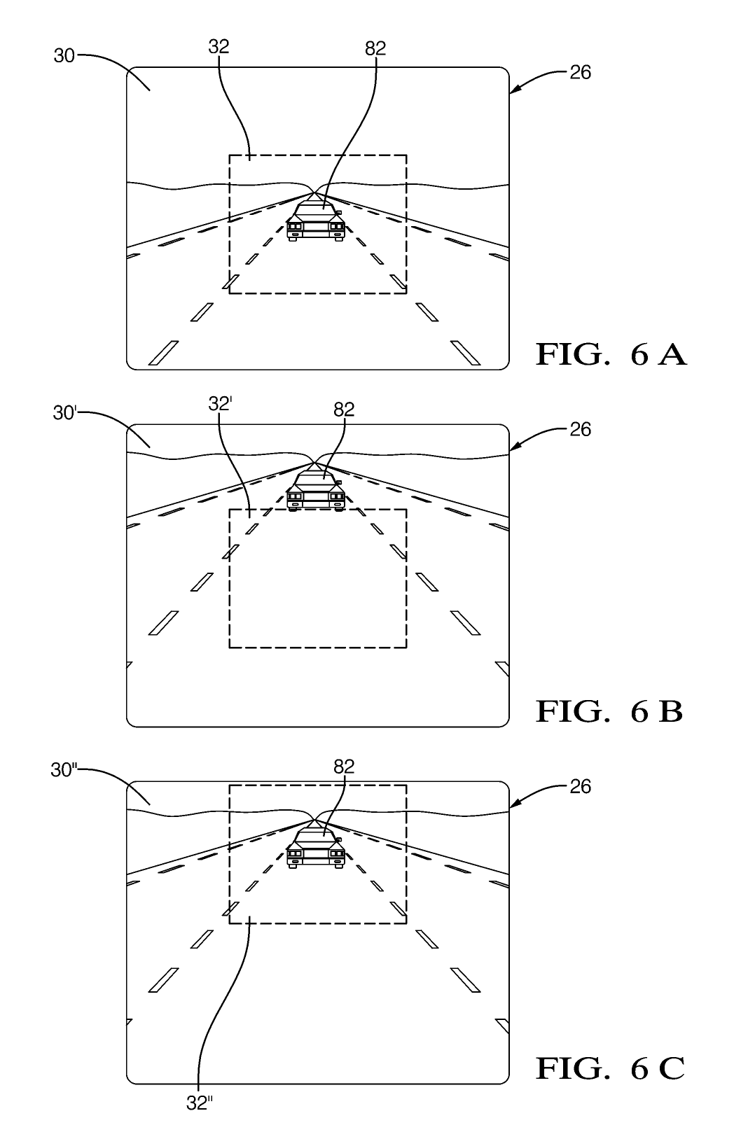

Referring to FIGS. 6A-6C, an automatic compensation for vehicle tilt feature is illustrated. When a host vehicle 10 is either loaded to assume an offset longitudinal axis (Y axis in FIG. 1), such as when a heave trailer is attached to a rear bumper, integral accelerometers/inclinometers 56, 58 or data from exiting vehicle accelerometers/inclinometers can be employed to reconfigure the image area 32. Furthermore, this feature can be used to mitigate the effects of vehicle “topping” and “bottoming” in undulating road courses.

FIG. 6A illustrates a display 26 with a field of vision 30 and an image area 32 centered on a trailing vehicle 82. FIG. 6B illustrates a condition wherein the host vehicle (carrying the electronic side view display system) has assumed a “tail low” condition due to overloading. As a result, the fixed rear view camera 16 also has an altered field of view 30′. As a result, the altered image area 32′ is no longer centered on the trailing vehicle 82. In response, the controller receives a signal from the inclinometer 56 and calculates a new position for the image area 32′ to best approximate its original position. As a result, the controller repositions the image area 32″ as illustrated in FIG. 6C as a function of the detected changes to vehicle pitch, yaw and roll inputs. As a result, the image area discerned by the operator is largely unchanged. Such corrections take place in near real-time, and can also accommodate for a rolling terrain. Furthermore, inputs from a lateral accelerometer can be employed to provide side-to-side stabilization of yaw induced vehicle excursions.

In the described embodiment, a side view vision system is mounted on an automobile. Alternately, the side view vision system may be used on other vehicles such as construction equipment operating in the vicinity of other construction vehicles and construction workers, where the determined portion is based on a transmission selector or the actuation of a position control lever on the construction equipment. Also, in the described embodiment, the vehicle is equipped with an automatic transmission. Alternately, a vehicle having a side view vision system has a manual transmission having at least one gear for traveling backward, and one gear or more gears of differing ratios for traveling forward.

Therefore, a side view system using a camera to capture an image of an area alongside and extending rearward a vehicle, and a display to show a driver a view of a portion of the image for various vehicle operations such as backing up or changing lanes is provided. The view can be rapidly optimized because the system does not rely on mechanical position controls. The system will also be more reliable and cost effective because is does not have moving parts. The camera can be positioned and portions determined to provide the driver with a view that is readily comprehended when compared to conventional minors while providing coverage of blind spots present with conventional side view mirrors. Arranging the camera to capture an image covering an area larger than required for viewing allows the center and magnification of the view can change faster, in response to changes in the vehicle operation such as the vehicle shifting into reverse or the driver preparing to make a lane change, than would be possible with mechanical position controls or mechanical camera zoom controls. Sufficient display resolution when displaying only a portion of an image captured by a camera is possible because of the availability of high resolution cameras. Use of high pixel count cameras improves the resolution of the displayed portion when displaying a portion of an image captured by a camera. Furthermore, as the cost of these cameras decreases, the method and apparatus described herein becomes more cost effective when compared to side view vision systems that require mechanical movement.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, the display could be incorporated near or adjacent a conventional minor apparatus such as a conventional side view minor or rear view minor. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A vehicle side view display system comprising:
at least one camera carried on a surface of an associated vehicle and disposed to focus on a fixed field of view externally of said vehicle, said camera operative to generate output signals as a function of objects disposed throughout said fixed field of view;
at least one display device disposed within the vehicle in the driver/passenger's forward field of vision; and
control means interconnecting said camera and display device operative to receive said output signals from said camera, process said signals and to display an image area portion of said field of view on said display device depicting selected objects located within said field of view.

2. The side view display system of claim 1, further comprising sensor means operative to detect angular displacement of said vehicle from its nominal longitudinal axis and to generate an output signal as a function thereof,
wherein said control means is operative to reposition the image area portion of said field of view on said display device as a function of said sensor output signal.

3. The side view display system of claim 1, wherein said control means processes said signals and displays said image in substantially real time.

4. The side view display system of claim 1, wherein said system includes an electronically-adjustable image area feature.

5. The side view display system of claim 1, wherein said system includes an augmented reality (i.e. overlaid information) feature.

6. The side view display system of claim 1, wherein said system includes a split screen/multiple images feature.

7. The side view display system of claim 1, wherein said system includes an object recognition enhancement feature.

8. The side view display system of claim 1, wherein said system includes an automatic compensation for vehicle tilt feature.

9. The side view display system of claim 1, wherein said system includes a grid or markers superimposed on the image display.

10. The side view display system of claim 9, wherein said grid/markers varies in intensity, color, scale or the like in response to detecting an object within the display field which is moving relative to the vehicle.

11. The side view display system of claim 1, further comprising a mirror incorporated within or adjacent the display device.

12. The side view display system of claim 11, wherein said minor is visible to the vehicle driver/passenger only upon actuation of a control device or failure of functionality of said display system.

13. A side view display system adapted for replacing vehicle driver and passenger side view minor systems, said display system comprising:
at least one camera disposed to focus on a field of view externally of an associated vehicle;
at least one display device disposed within the vehicle in the driver/passenger's field of vision; and
control means interconnecting said camera and display device operative to receive signals from said camera, process said signals and to display an image on said display device depicting objects located within said field of view.
